(19) United States
(12) Patent Application Publication
(10) Pub. No.: US 2015/0278380 A1
(43) Pub. Date: Oct. 1, 2015

(54) Direct Search Method and Apparatus

(71) Applicant: TENCENT TECHNOLOGY (SHENZHEN) COMPANY LIMITED, Shenzhen (CN)

(72) Inventors: Yanjie Wen, Shenzhen (CN); Yi Zhao, Shenzhen (CN); Ningjun Dou, Shenzhen (CN); Liang Zeng, Shenzhen (CN); Meina Li, Shenzhen (CN); Jianchun Wang, Shenzhen (CN); Zhiqing Zhou, Shenzhen (CN)

(21) Appl. No.: 14/737,561

(22) Filed: Jun. 12, 2015

Related U.S. Application Data
(63) Continuation of application No. PCT/CN2013/089753, filed on Dec. 18, 2013.

(30) Foreign Application Priority Data
Dec. 24, 2012 (CN) 201210567829.0

(51) Int. Cl. G06F 17/30; G06F 3/0482; G06F 3/0484

(52) U.S. Cl. CPC G06F 17/30867; G06F 17/3053; G06F 3/04842; G06F 3/0482

(57) ABSTRACT

The examples of the present disclosure disclose a direct search method and apparatus to facilitate the user to search an object rapidly, thus improving the search efficiency. The method comprises: obtaining an inputted search keyword; performing search according to the search keyword and displaying search results of the search on a search interface corresponding to the search classifications; and after receiving an operation for a certain search result in the search results via the search interface corresponding to the search classifications, directly accessing content corresponding to the certain search result. And the method provided by the examples of the present disclosure may position a search object of a user precisely, reducing the interference by useless information, searching the content that the user actually needs and improving the search efficiency under massive information.

### CROSS REFERENCE TO RELATED APPLICATIONS

This application is a continuation application of PCT Patent Application No. PCT/CN2013/089753, entitled “A Direct Search Method and Apparatus” filed on Dec. 18, 2013, which claims the benefit and priority of Chinese Patent Application No, 201210567829.0, entitled “A Direct Search Method and Apparatus” filed on Dec. 24, 2012, both of which are incorporated by reference in their entirety.

### TECHNICAL FIELD

The present disclosure relates to the field of internet applications, and especially to a direct search method and apparatus.

### BACKGROUND

With the development of internet technology, more and more information can be obtained from the internet, and people can obtain the information more rapidly and more comprehensively. However, with the massive information being provided, it becomes more and more difficult for a user to find information exactly he needs among the massive information. The search engine is used to search information that a user needs as exactly as it can, to improve the efficiency of obtaining information.

When existing search engines search information at its best, the search engines will return a lot of search results, resulting in that a user often needs to try a lot of keywords over and over again and open a plurality of web pages that correspond to every keyword; however, in these web pages, some are slow, have a lot of advertisements, and are even full of Trojans. Generally, when a user uses a search engine, the search results he needs are easily to be shown by a paragraph of words and/or an image, while the search engines in the existing techniques can only return a plenty of links of the search results, and the user can only find the content actually he needs by opening respective links one by one, which will eventually result in that the process that the user obtains the data is complicated.

### SUMMARY

The examples of the present disclosure provide a direct search method and apparatus to facilitate the user searching objects rapidly and to improve the search efficiency.

An example of the present disclosure provides a direct search method, the method including:

displaying search classifications on a search interface of a client, wherein the search classifications include at least one of web page, image, video, and article;

obtaining an inputted search keyword;

performing search according to the search keyword;

displaying search results of the search on the search interface corresponding to the search classifications;

receiving an operation for a certain search result in the search results via the search interface corresponding to the search classifications; and

accessing content corresponding to the certain search result.

An example of the present disclosure provides a direct search apparatus, the apparatus including:

a classified display module, to display search classifications on a search interface of a client, wherein the search classifications include at least one of web page, image, video and article;

a keyword obtaining module, to obtain an inputted search keyword;

a result display module, to perform search according to the search keyword obtained by the keyword obtaining module and display search results of the search on the search interface corresponding to the search classifications; and

a direct access module, to receive an operation for a certain search result in the search results via the search interface corresponding to the search classifications, and access the content corresponding to the certain search result.

An example of the present disclosure provides a direct search apparatus, including:

one or more processors;

a memory; and

one or more program modules stored in the memory and to be executed by the one or more processors, the one or more program modules include:

a classified display module, to display search classifications on a search interface of a client, wherein the search classifications include at least one of web page, image, video, and article;

a keyword obtaining module, to obtain an inputted search keyword;

a result display module, to perform search according to the search keyword obtained by the keyword obtaining module and display search results of the search on the search interface corresponding to the search classifications; and

a direct search module, to receive an operation for a certain search result in the search results via the search interface corresponding to the search classifications, and access content corresponding to the certain search result.

An example of the present disclosure provides a non-transitory computer-readable storage medium including a set of instructions for managing direct search software, the set of instructions to direct at least one processor to perform acts of:

displaying search classifications on a search interface of a client, wherein the search classifications include at least one of web page, image, video, and article;

obtaining an inputted search keyword;

performing search according to the search keyword;

displaying search results of the search on the search interface corresponding to the search classifications; and

receiving an operation for a certain search result in the search results via the search interface corresponding to the search classifications; and

accessing content corresponding to the certain search result.

As is known from the above examples of the present disclosure, since when the search results are displayed on the search interface of the client and an operation for a certain search result in the search results is performed, the content corresponding to the certain search result can be accessed directly, compared with that, in the existing art, the search engines in the existing art can only return links of a plenty of search results, and a user needs to open respective links one by one to find the content he actually needs, the examples of the present invention can precisely position the search objects of the user, reduce the interference of useless information, search the content that the user actually needs quickly, improving search efficiency even with massive information.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a schematic diagram of a flowchart of a direct search method provided by an example of the present disclosure;

FIG. 2 is a schematic diagram of a structure of a direct search apparatus provided by an example of the present disclosure;

FIG. 3 is a schematic diagram of a structure of a direct search apparatus provided by another example of the present disclosure;

FIG. 4-a is a schematic diagram of a structure of a direct search apparatus provided by another example of the present disclosure;

FIG. 4-b is a schematic diagram of a structure of a direct search apparatus provided by another example of the present disclosure; and

FIG. 5 is a schematic diagram of a structure of a direct search apparatus provided by an example of the present disclosure.

### DETAILED DESCRIPTION

Reference will now be made in detail to examples, which are illustrated in the accompanying drawings. In the following detailed description, numerous specific details are set forth in order to provide a thorough understanding of the present disclosure. Also, the figures are illustrations of an example, in which modules or procedures shown in the figures are not necessarily essential for implementing the present disclosure. In other instances, well-known methods, procedures, components, and circuits have not been described in detail so as not to unnecessarily obscure aspects of the examples.

Please refer to FIG. 1, which is a schematic diagram of a flowchart of a direct search method provided by an example of the present disclosure, the executive body thereof may be a browser on a PC or a browser on a mobile terminal, and mainly includes the following step S101, step S102, step S103 and step S104, the detailed description thereof is as follows:

S101, displaying search classifications on a search interface of the client, the search classifications including web page, image, video and/or article.

As for a same search keyword, there are many corresponding search results that may belong to different classifications. For example, search results corresponding to the search keyword “1942” may be an article recording a certain history event that happened in 1942, or may be the movie “Back To 1942” recently shown on line. To improve the search efficiency, search classifications may be shown on a search interface of a client and the search classifications include web page, image, video and/or article, etc. As such, when the user is intended to search the movie, he may firstly select a video sub-interface of the search interface, and then perform related subsequent operations. For example, if the user is intended to watch the movie “Back To 1942” recently shown on line, then the user may first select the video sub-interface of the search interface, and then perform related subsequent operations, e.g., clicking a “play” button to play on line. Therefore, it will not incur that after the operation on the search results of “1942”, what is gotten is an article recording a certain history event that happened in 1942.

S102, obtaining an inputted search keyword.

In the example of the present disclosure, the search keyword inputted by the user may be received from a search engine main page of the browser or from an input box of a search tool (e.g., an address bar or a search bar, etc.). Of course, the present disclosure may use other commonly used methods to obtain the search keyword, and the present disclosure should not be limited to this. Among these, the search keyword may be directly inputted by the user and may also be parsed according to the user's input. The present disclosure has not defined the specific method of “input”, and when using the present disclosure, a variety of input methods may be used. For example, a keyboard input method (including a virtual keyboard or a physical keyboard, etc.), a copy and paste method, a link automatic selection method (e.g., starting the search engine after the mouse selects a certain word), a speech input method, a touch screen/board trajectory input method, etc. may be used.

S103, performing the search according to the search keyword and displaying search results of the search on the search interface corresponding to the search classifications.

In the example of the present disclosure, the search according to the inputted search keyword is performed backstage, while display of the search results may be performed on the search interface corresponding to the search classifications of the client, and the specific display position may be a dropdown box below an input box. What needs to be specified is that the “search result” here does not mean final present of an object that the user needs to search, but is a primary result gotten by association according to the keyword. For example, when the user inputs a search keyword “WeChat”, after the search is performed backstage, the search results shown on the search interface corresponding to the search classifications of the client may be “WeChat”, “WeChat free download” and “WeChat version 2012”, etc.

To find the content that the user actually needs to search as quickly as possible and to improve the search efficiency, as an example of the present disclosure that performs the search according to the search keyword and displays the search results on a search interface corresponding to the search classifications of the client, it may match the preference degree of the user for the search results corresponding to the search keyword after the search is performed according to the search keyword. Specifically, since when the user uses the search engine, he will select web pages that he needs from a search result index page by viewing information such as abstracts or names, etc., e.g., surfing web sites by clicking hyperlinks on the search result index page. By recording related information of “search keyword oclick operation” of the user, when the user inputs a certain search keyword, it may match the preference degree of the search results corresponding to the search keyword of the user. Among them, the preference degree of the user for the search results corresponding to the search keyword may be measured by the number of times viewing the search results, for example, the more views of a certain search result, the higher degree that the user prefers the search result; it may also be measured according to the view duration, whether copy and/or save operation(s) being performed, etc., for a certain search result page that is opened.

After matching the preference degree of the user for the corresponding search results of the search keyword, only the search results with high preference degree may be displayed on the search interface of the client, and therefore, the efficiency of the user searching the target content is highly improved.

S104, after an operation for a certain search result in the search results is received from the search interface corresponding to the search classifications, accessing the content corresponding to the certain search result directly.

In the example of the present disclosure, the operation for the certain search result in the search results includes clicking the certain search result in the search results, or clicking a functional button adjacent to the certain search result. For example, when the search keyword “WeChat” is inputted and the search results displayed on the search interface of the client are “WeChat”, “WeChat free download” and “WeChat version 2012”, if the “WeChat version 2012” is the search result that the user wants, then the user clicks the search result of “WeChat version 2012” directly, and accesses the content corresponding to the search result of “WeChat version 2012”, e.g., a web page, etc. In the example of the present disclosure, functional buttons, e.g., buttons of “download”, “play”, etc. may be shown adjacent to the search results. Therefore, the operation for the certain search result in the search results may be clicking the functional button displayed adjacent to the certain search result in the search results, for example, when the inputted search keyword is “ice and fire”, and the search results shown on the search interface of the client may be “ice and fire”, “ice and fire pdf”, “a song of ice and fire”, etc. And if the purpose of the user performing the search is to watch the new movie “a song of ice and fire” on line, he may directly press the functional button “play” shown adjacent to “a song of ice and fire” and directly access the content corresponding to the search result of “a song of ice and fire”, i.e., playing the movie “a song of ice and fire” on line directly.

In the example of the present disclosure, if the displayed page of the direct search is not consistent with what the user needs at this time, then the user may perform a backward operation to display a search result index page. The so called search result index page is a web page that the search engine displays the search results gotten after processing and organizing, e.g., with high preference degree, to the user according to the search keyword provided by the user. In other words, in the example of the present disclosure, when a certain search result is incorrect, a search result index page of the real-time search of this time may be shown to the user, without affecting the normal usage of the search engine. Specifically, the backward operation may be realized in various ways, e.g., directly clicking a backward button on the browser; or clicking a backward button on a floating window or on a direct search tool bar, to realize the execution of the backward operation. Of course, it should be noted that the backward operation is not the traditional backward operation, and in fact, the search result index page gotten from the backward operation has not been displayed before.

As is known from the direct search method provided by the example of the present disclosure, since when the search results are displayed on the search interface corresponding to the search classifications, after an operation for a certain search result in the search results is performed, the content corresponding to the certain search result may be accessed directly. Compared with the fact that in the prior art, the search engines in the existing technology may only return links of a plenty of search results and a user needs to open the respective links one by one to find the content he actually needs, the method provided by the example of the present disclosure may precisely position a search object of the user, reduce the interference of useless information, rapidly find the content that the user actually needs to search, and improve the search efficiency of massive information.

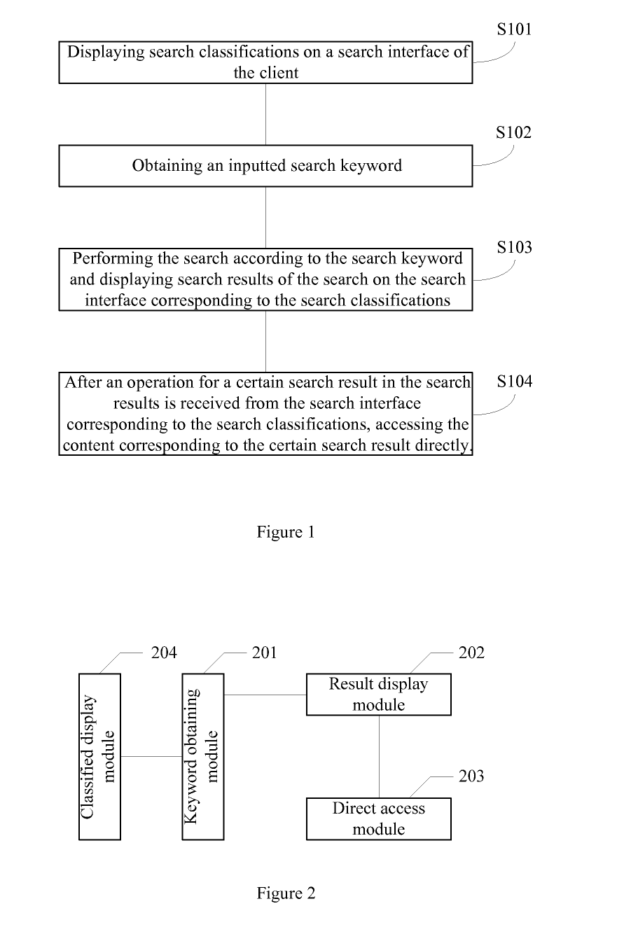

Please refer to FIG. 2, which is a schematic diagram of a structure of the direct search apparatus provided by an example of the present disclosure. To facilitate illustration, only a part related to the example of the present disclosure is shown. The direct search apparatus shown in FIG. 2 may be a browser of a personal computer or a browser of a mobile terminal, or a certain functional module/unit of a PC browser or a mobile terminal browser, which includes a keyword obtaining module 201, a result display module 202, a direct access module 203 and a classified display module 204, wherein:

the classified display module 204 is configured to display search classifications on a search interface of a client, and the search classifications include web page, image, video and/or article;

the keyword obtaining module 201 is configured to obtain an inputted search keyword;

the result display module 202 is configured to perform search according to the search keyword obtained by the keyword obtaining module 201 and display search results of the search on a search interface corresponding to the search classifications; and

the direct access module 203 is configured to, after it receives an operation for a certain search result in the search results via the search interface corresponding to the search classifications, directly access the content corresponding to the certain search result. Among these, the operation for the certain search result in the search results includes clicking the certain search result in the search results or clicking a functional button displayed adjacent to the certain search result, etc.

It is to be noted that, in the above example of the direct search apparatus, the division of the respective functional modules is only used for illustration, and in the implementation, it may be divided as needs, e.g., in consideration of the configuration requirements of corresponding hardware or convenience of realization by software, the above functions may be allocated to and carried out by different functional modules, that is, the inner structure of the direct search apparatus is divided into different functional modules to carry out the above all of or a part of functions. Meanwhile, in the practice, the corresponding functional modules in the present example may be realized by corresponding hardware and may also be carried out by corresponding software that is executed by corresponding hardware, e.g., the above mentioned result display module may be hardware that carries out the search according to the search keyword obtained by the keyword obtaining module (or the keyword obtainer) and displaying the search results of the search on the search interface corresponding to the search classifications, e.g., a result displayer, and it may be a general processor or other hardware that may execute corresponding computer programs so as to carry out the above mentioned functions; further, regarding the direct access module mentioned above, it may be hardware that has a function of, after receiving an operation for a certain search result in the search results via the search interface corresponding to the search classifications, accessing the content corresponding to the certain search result directly, e.g., a direct accessor, or may be a general processor or other hardware device that may execute corresponding computer programs so as to carry out the above functions (the above described principle is applicable to various examples provided by the present disclosure).

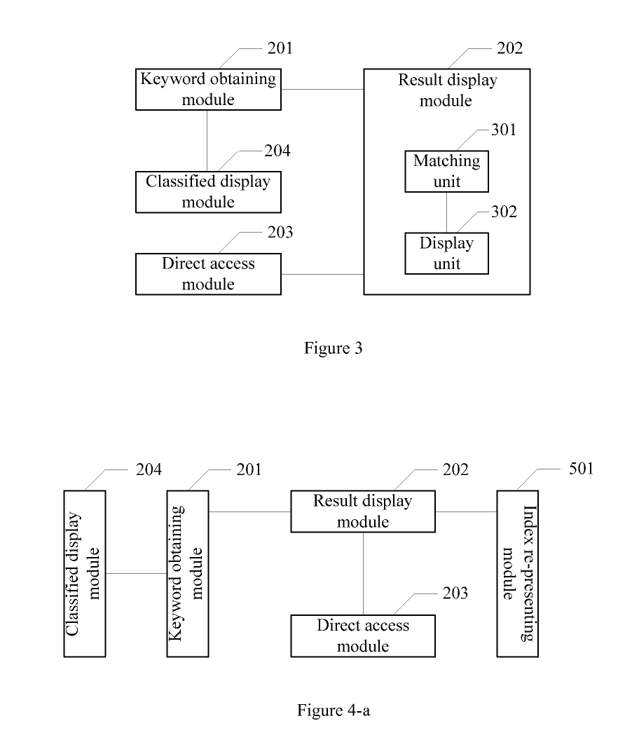

The exemplary result display module 202 of FIG. 2 may include a matching unit 301 and a display module 302, as the direct search apparatus provided by another example of the present disclosure as shown in FIG. 3, wherein:

the matching unit 301 is configured to match the preference degree of the user for the search results corresponding to the search keyword after the search is performed according to the search keyword; and the display unit 302 is configured to display the search results with a high preference degree on the search interface corresponding to the search classifications.

Since when the user uses the search engine, he will select web pages he needs from the search result index page by viewing information such as abstracts or names, etc., e.g., surfing web sites by clicking hyperlinks in the search result index page. By recording the association information of “search keyword->click operation” of the user, when the user inputs a certain search keyword, in the direct search apparatus shown in FIG. 3, the matching unit 301 may match the preference degree of the user for the search results corresponding to the search keyword. Among them, the preference degree of the user for the search results corresponding to the search keyword may be measured by the number of times viewing the search results, for example, the more views of a certain search result, the higher degree that the user prefers the search result; it may also be measured according to the view duration, whether copy and/or save operation(s) being performed, etc., for a certain search result page that is opened.

After the matching unit 301 matches the preference degree of the users for the corresponding search results of the search keyword, the display unit 302 may only display the search results with high preference degrees on the search interface corresponding to the search classifications, and thus, the efficiency of the user searching the target content is extremely improved. The direct search apparatus provided by FIG. 2 or FIG. 3 may include an index re-presenting module 401, as the direct search apparatus provided by another example of the present disclosure shown in FIG. 4-a or FIG. 4-b. The index re-presenting module 401 is configured to, when the user executes the backward operation, display an index page of the search results. In other words, in the current example, when a certain search result is incorrect, the index re-presenting module 401 still may display the index page of the search results of the present real-time search, without affecting the user normally using the search engine. Specifically, the backward operation may be realized in various ways, for example, by clicking a backward button directly on a browser; or clicking a backward button on a floating window or on a direct search tool, etc. may realize the execution of the backward operation. Of course, it should be noted that the backward operation is not the traditional backward operation, because, in fact, the search result index page gotten from the backward operation has not been shown before.

It should be known that, since the content of information interaction, execution process etc. among respective modules/units of the above apparatus are based on a concept that is the same with the method examples of the present disclosure, the technical results brought out thereby are the same with those of the examples of the present disclosure, and for the detailed content, please refer to the description in the method examples of the present disclosure and will not be elaborated herein.

The ordinary skilled in the art may understand that all of or a part of the steps in the various methods of the present examples may be carried out by programs commanding related hardware, such as one of or a variety of or all of the following methods:

displaying searching classifications on a search interface of the client, the search classifications including webpage, image, video and/or article;

obtaining an inputted search keyword;

performing search according to the search keyword and displaying search results of the search on a search interface corresponding to the search classifications; and

after receiving an operation for a certain search result in the search results via the search interface corresponding to the search classifications, directly accessing the content corresponding to the certain search result.

The foregoing description of a direct search method and apparatus of the examples of the present disclosure, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

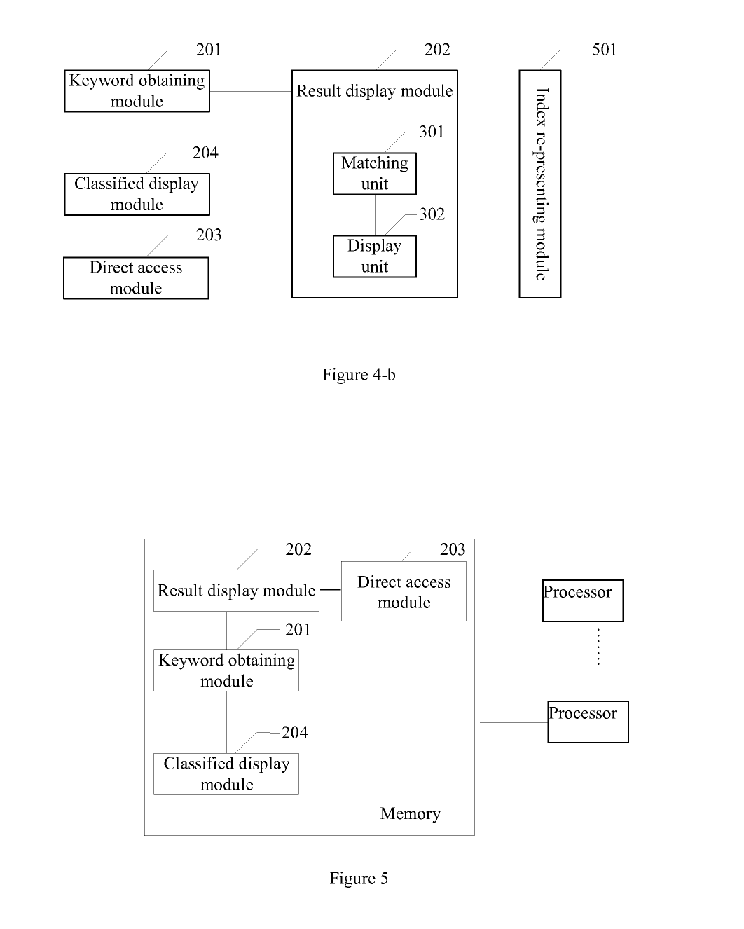

FIG. 5 is a schematic diagram of a structure of a direct search apparatus provided by an example of the present disclosure. The direct search apparatus includes: one or more processors; a memory; and one or more program modules stored in the memory and to be executed by the one or more processors, wherein the one or more program modules include: a classified display module 204, to display search classifications on a search interface of a client, wherein the search classifications include at least one of web page, image, video, and article; a keyword obtaining module 201, to obtain an inputted search keyword; a result display module 202, to perform search according to the search keyword obtained by the keyword obtaining module 201 and display search results of the search on the search interface corresponding to the search classifications; and a direct search module 203, to receive an operation for a certain search result in the search results via the search interface corresponding to the search classifications, and access content corresponding to the certain search result.

The present disclosure provides a non-transitory computer-readable storage medium comprising a set of instructions for managing direct search software, the set of instructions to direct at least one processor to perform acts of: displaying search classifications on a search interface of a client, wherein the search classifications include at least one of web page, image, video, and article; obtaining an inputted search keyword; performing search according to the search keyword; displaying search results of the search on the search interface corresponding to the search classifications; and receiving an operation for a certain search result in the search results via the search interface corresponding to the search classifications; and accessing content corresponding to the certain search result.

The above examples may be implemented by hardware, software, firmware, or a combination thereof. For example the various methods, processes and functional modules described herein may be implemented by a processor (the term processor is to be interpreted broadly to include a CPU, processing unit/module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. The modules, if mentioned in the aforesaid examples, may be combined into one module or further divided into a plurality of sub-modules. Further, the examples disclosed herein may be implemented in the form of a software product. The computer software product is stored in a non-transitory storage medium and includes a plurality of instructions for making an electronic device implement the method recited in the examples of the present disclosure.

What is claimed is:

1. A search method, comprising:
displaying search classifications on a search interface of a client;
obtaining an inputted search keyword;
performing search according to the search keyword;
displaying search results of the search on the search interface corresponding to the search classifications;
receiving an operation for a certain search result in the search results via the search interface corresponding to the search classifications; and
accessing content corresponding to the certain search result.

2. The method according to claim 1, wherein displaying the search results of the search on the search interface corresponding to the search classifications comprises:
after performing the search according to the search keyword, matching a user's preference degree for search results corresponding to the search keyword; and
displaying search results with high preference degree on the search interface corresponding to the search classifications.

3. The method according to claim 1, wherein the operation for the certain search result in the search results comprises clicking the certain search result in the search results or clicking a functional button displayed adjacent to the certain search result in the search results.

4. The method according to claim 1, further comprising:
performing a backward operation to display an index page for the search results.

5. The method according to claim 1, wherein the search classifications comprise at least one of web page, image, video, and article.

6. The method according to claim 2, further comprising:
performing a backward operation to display an index page for the search results.

7. The method according to claim 3, further comprising:
performing a backward operation to display an index page for the search results.

8. The method according to claim 2, wherein the search classifications comprise at least one of web page, image, video, and article.

9. The method according to claim 3, wherein the search classifications comprise at least one of web page, image, video, and article.

10. A search apparatus, comprising:
a classified display module, to display search classifications on a search interface of a client, wherein the search classifications comprise at least one of web page, image, video, and article;
a keyword obtaining module, to obtain an inputted search keyword;
a result display module, to perform search according to the search keyword obtained by the keyword obtaining module and display search results of the search on the search interface corresponding to the search classifications; and
a direct search module, to receive an operation for a certain search result in the search results via the search interface corresponding to the search classifications, and access the content corresponding to the certain search result.

11. The apparatus according to claim 10, wherein the result display module comprises: a matching unit, to match a user's preference degree for search results corresponding to the search keyword after performing the search according to the search keyword; and
a display unit, to display the search results with high preference on the search interface corresponding to the search classifications.

12. The apparatus according to claim 10, wherein the operation for the certain search result in the search results comprises clicking the certain search result in the search results or clicking a functional button displayed adjacent to the certain search result in the search results.

13. The apparatus according to claim 10, further comprising:
an index re-presenting module, to display an index page for the search results when the user performs a backward operation.

14. The apparatus according to claim 10, wherein the search classifications comprise at least one of web page, image, video, and article.

15. The apparatus according to claim 11, further comprising:
an index re-presenting module, to display an index page for the search results when the user performs a backward operation.

16. The apparatus according to claim 12, further comprising:
an index re-presenting module, to display an index page for the search results when the user performs a backward operation.

17. The apparatus according to claim 11, wherein the search classifications comprise at least one of web page, image, video, and article.

18. The apparatus according to claim 12, wherein the search classifications comprise at least one of web page, image, video, and article.

19. A search apparatus, comprising:
one or more processors;
a memory; and
one or more program modules stored in the memory and to be executed by the one or more processors, the one or more program modules comprise:
a classified display module, to display search classifications on a search interface of a client;
a keyword obtaining module, to obtain an inputted search keyword;
a result display module, to perform search according to the search keyword obtained by the keyword obtaining module and display search results of the search on the search interface corresponding to the search classifications; and
a direct search module, to receive an operation for a certain search result in the search results via the search interface corresponding to the search classifications, and access content corresponding to the certain search result.

20. A non-transitory computer-readable storage medium comprising a set of instructions for managing direct search software, the set of instructions to direct at least one processor to perform acts of:
displaying search classifications on a search interface of a client;
obtaining an inputted search keyword;
performing search according to the search keyword;
displaying search results of the search on the search interface corresponding to the search classifications; and
receiving an operation for a certain search result in the search results via the search interface corresponding to the search classifications; and
accessing content corresponding to the certain search result.
